(19) United States
(12) Patent Application Publication
(10) Pub. No.: US 2021/0398098 A1
(43) Pub. Date: Dec. 23, 2021

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventor: Hideki NARUSAWA, Tokyo (JP)

(73) Assignee: NEC Corporation, Minato-ku, Tokyo (JP)

(21) Appl. No.: 17/271,243

(22) PCT Filed: Aug. 26, 2019
(86) PCT No.: PCT/JP2019/033271

§ 371 Date: Feb. 25, 2021

(30) Foreign Application Priority Data
Aug. 31, 2018 (JP) 2018-163017

(51) Int. Cl. G06Q 20/20; G07G 1/14

(52) U.S. Cl. CPC G06Q 20/202; G07G 1/14

(57) ABSTRACT

An information processing system according to the present invention includes a salesclerk-side terminal operated by a salesclerk; a customer-side terminal associated with the salesclerk-side terminal and operated by a customer; and a control unit that performs switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

### TECHNICAL FIELD

The present invention relates to an information processing system, an information processing method, and a storage medium.

### BACKGROUND ART

Patent Literature 1 discloses a semi-self-service type Point of Sales (POS) apparatus having a product data registration device by which a salesclerk registers product data and a checkout device by which a customer performs a checkout process based on transaction data transferred from the product data registration device.

### CITATION LIST

### Patent Literature

PTL 1: Japanese Patent Application Laid-open No. 2015-141651

### SUMMARY OF INVENTION

### Technical Problem

In Patent Literature 1, the checkout device functions as a self-service type POS apparatus that enables a customer to perform a product sales process and a checkout process when the product data registration device is idle. However, the checkout device does not have a function as a face-to-face type POS apparatus that enables a salesclerk and a customer facing each other to perform a checkout process. That is, the checkout apparatus is unable to perform switching between functions of a face-to-face type POS and a self-service type POS at a suitable timing.

Accordingly, in view of the above problem, the present invention intends to provide an information processing system, an information processing method, and a storage medium that can perform switching between a face-to-face type POS and a self-service type POS at a suitable timing.

### Solution to Problem

According to one example aspect of the present invention, provided is an information processing system including: a salesclerk-side terminal operated by a salesclerk; a customer-side terminal associated with the salesclerk-side terminal and operated by a customer; and a control unit that performs switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

According to another example aspect of the present invention, provided is an information processing method including: operating a salesclerk-side terminal; operating a customer-side terminal associated with the salesclerk-side terminal; and performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

According to yet another example aspect of the present invention, provided is a storage medium storing a program that causes a computer to perform: operating a salesclerk-side terminal; operating a customer-side terminal associated with the salesclerk-side terminal; and performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

### Advantageous Effects of Invention

According to the present invention, an information processing system, an information processing method, and a storage medium that can perform switching between a face-to-face type POS and a self-service type POS at a suitable timing can be provided.

### BRIEF DESCRIPTION OF DRAWINGS

FIG. 1 is a block diagram illustrating an overall configuration example of a POS system according to a first example embodiment.

FIG. 2 is a perspective view of a POS apparatus according to the first example embodiment.

FIG. 3 is a perspective view of the POS apparatus according to the first example embodiment.

FIG. 4 is a perspective view of the POS apparatus according to the first example embodiment.

FIG. 5 is a block diagram illustrating a hardware configuration example of the POS apparatus according to the first example embodiment.

FIG. 6 is a flowchart illustrating an example of a switching process of a checkout mode in the POS system according to the first example embodiment.

FIG. 7 is a diagram illustrating an example of a checkout mode selection window displayed on a customer-side terminal according to the first example embodiment.

FIG. 8 is a flowchart illustrating an example of a checkout process in the POS system according to the first example embodiment.

FIG. 9 is a diagram illustrating an example of a product registration window displayed on the customer-side terminal according to the first example embodiment.

FIG. 10 is a diagram illustrating an example of a payment method selection window displayed on the customer-side terminal according to the first example embodiment.

FIG. 11 is a flowchart illustrating an example of a switching process of a checkout mode in a POS system according to a second example embodiment.

FIG. 12 is a diagram illustrating an example of a lock window displayed on a salesclerk-side terminal according to the second example embodiment.

FIG. 13 is a flowchart illustrating an example of a switching process of a checkout mode in a POS system according to a third example embodiment.

FIG. 14 is a block diagram illustrating a function of an information processing system according to a fourth example embodiment.

### DESCRIPTION OF EMBODIMENTS

Exemplary example embodiments of the present invention will be described below with reference to the drawings. In the drawings, the same components or corresponding components are labeled with the same references, and the description thereof may be omitted or simplified.

### First Example Embodiment

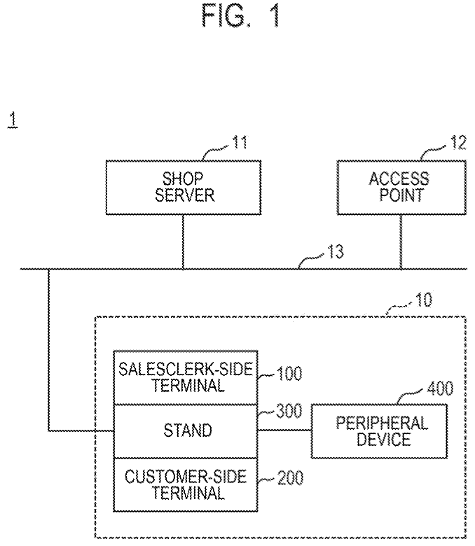

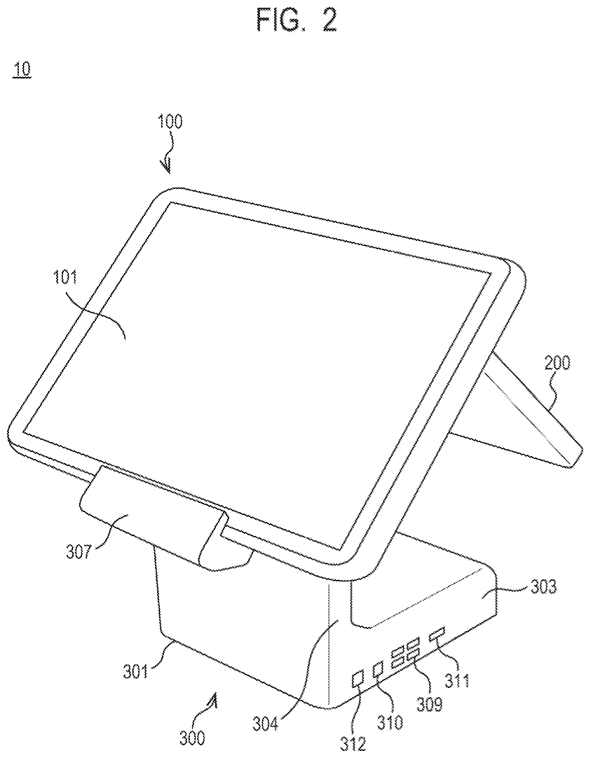

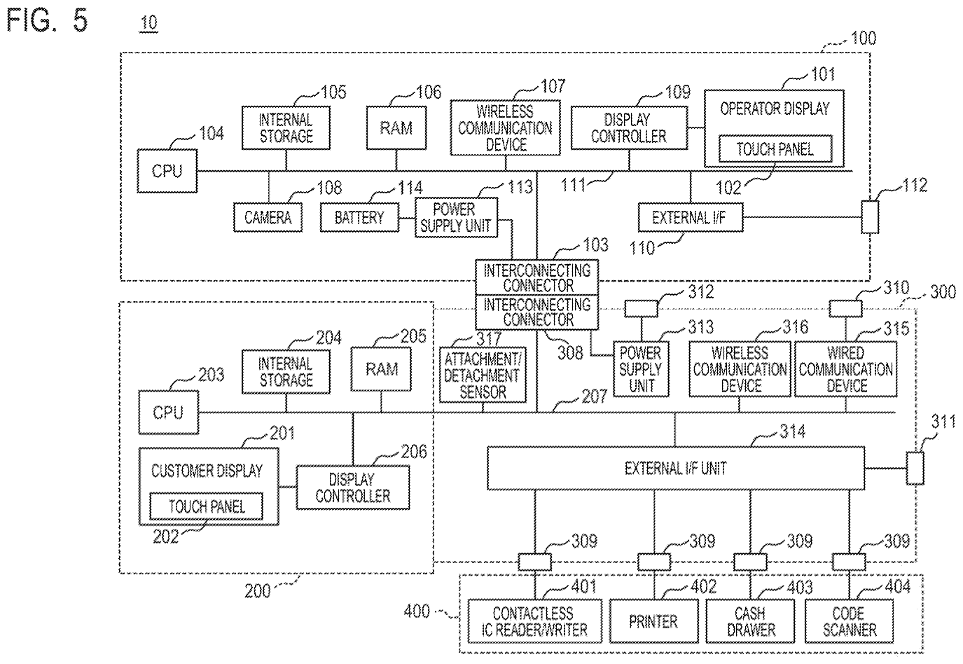

FIG. 1 is a block diagram illustrating an overall configuration example of a POS system 1 according to the present example embodiment. FIG. 2 to FIG. 4 are perspective views illustrating a configuration of a POS apparatus 10 used for the POS system 1. FIG. 5 is a block diagram illustrating a hardware configuration example of the POS apparatus 10.

The POS system 1 is an information processing system introduced in a shop that sells products. As illustrated in FIG. 1, the POS system 1 has the POS apparatus 10, a shop server 11, and an access point 12. The POS apparatus 10, the shop server 11, and the access point 12 are connected to a network 13 that is a local area network (LAN), for example.

The POS apparatus 10 is an information processing apparatus having a salesclerk-side terminal 100, a customer-side terminal 200, a stand 300, and a peripheral device 400. In the present example embodiment, the POS apparatus 10 is installed in a register counter of the shop. Note that the number of POS apparatuses 10 is not particularly limited, and any number thereof can be further installed in accordance with the scale of the shop or the like. Although the POS apparatus 10 will be described below as the salesclerk-side terminal 100 being detachable from the stand 300, the configuration of the POS apparatus 10 is not limited to the above. For example, in the POS apparatus 10, the salesclerk-side terminal 100, the customer-side terminal 200, and the stand 300 may be integrally formed. Also, in the POS apparatus 10 having such a configuration, the checkout process can be performed in the customer-side terminal 200 even when the salesclerk-side terminal 100 is unable to perform a checkout process due to absence of a salesclerk or the like, for example. Accordingly, it is possible to perform a checkout process efficiently.

The salesclerk-side terminal 100 is a terminal operated by the salesclerk at the register counter or the like and performs the checkout process in cooperation with the customer-side terminal 200 and the peripheral device 400. The salesclerk-side terminal 100 is provided in the stand 300 in a detachable manner. That is, the salesclerk can use the salesclerk-side terminal 100 in both of a state where the salesclerk-side terminal 100 is supported by and electrically connected to the stand 300 (hereinafter, referred to as “connected state”) and a state where the salesclerk-side terminal 100 is detached from the stand 300 (hereinafter, referred to as “detached state”).

The salesclerk-side terminal 100 in a connected state is connected to the network 13 in a wired manner via a wired communication device (see FIG. 5) provided in the stand 300. Thereby, the salesclerk-side terminal 100 can transmit and receive data to and from the shop server 11 or other external devices via the network 13 by wired communication. Note that the connection between the salesclerk-side terminal 100 in a connected state and the network 13 is not limited to the above.

On the other hand, the salesclerk-side terminal 100 in the detached state is wirelessly connected to the network 13 by wireless communication with the access point 12. Thereby, the salesclerk-side terminal 100 in the detached state can transmit and receive data to and from the shop server 11 or other external devices via the network 13 by wireless communication.

The customer-side terminal 200 is a terminal having a function as a display unit that provides information to a customer in the register counter and a function as an input unit that accepts input from the customer. The customer-side terminal 200 of the present example embodiment can perform a checkout process instead of the salesclerk-side terminal 100 when the salesclerk-side terminal 100 is in state unable to perform a checkout process. The switching of a checkout mode will be described later.

The stand 300 is a support member that supports the salesclerk-side terminal 100 and the customer-side terminal 200. In the present example embodiment, the salesclerk-side terminal 100 is provided in a manner detachable from the stand 300, and the customer-side terminal 200 and the stand 300 are integrally provided. Note that the customer-side terminal 200 may be provided to the stand 300 in a detachable manner in the same manner as the salesclerk-side terminal 100.

The peripheral device 400 is connected to the stand 300. The peripheral device 400 includes a contactless integrated circuit (IC) reader/writer 401, a printer 402, a cash drawer 403, a code scanner 404, and the like described later (see FIG. 2 to FIG. 5). The salesclerk-side terminal 100 can control the peripheral device 400 via the stand 300.

In such a way, the stand 300 also functions as a cradle or a docking station that is an extension unit that extends the function of the salesclerk-side terminal 100 attached thereto.

The shop server 11 is a store controller that performs management of information on products sold in the shop, aggregation of sales data, management of sales proceeds, management of inventory, or the like and manages the operation of the POS system 1, for example. The shop server 11 is installed in a backyard of the shop, for example.

The access point 12 is a wireless communication device that wirelessly communicates with the salesclerk-side terminal 100 in a detached state and connects the salesclerk-side terminal 100 to the network 13. The access point 12 is installed on a ceiling or the like of the shop, for example. Further, one or a plurality of access points 12 may be installed in accordance with the scale of the shop, a radio environment, or the like, for example.

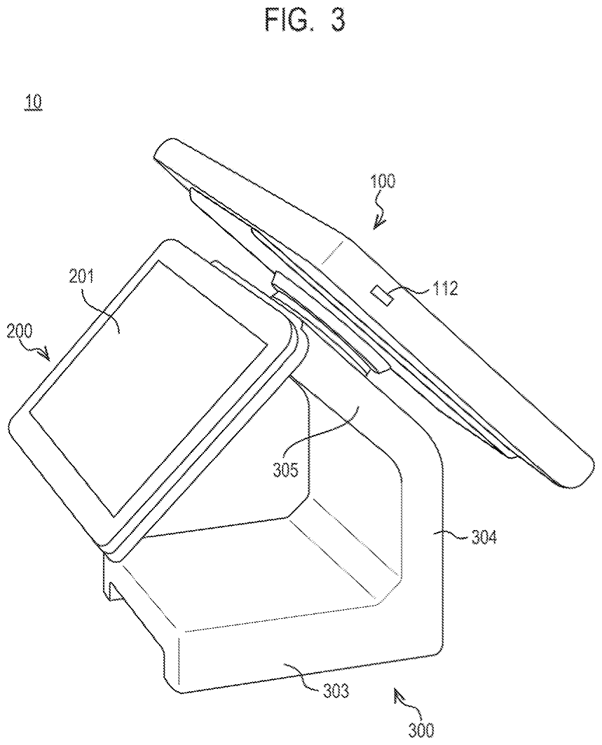

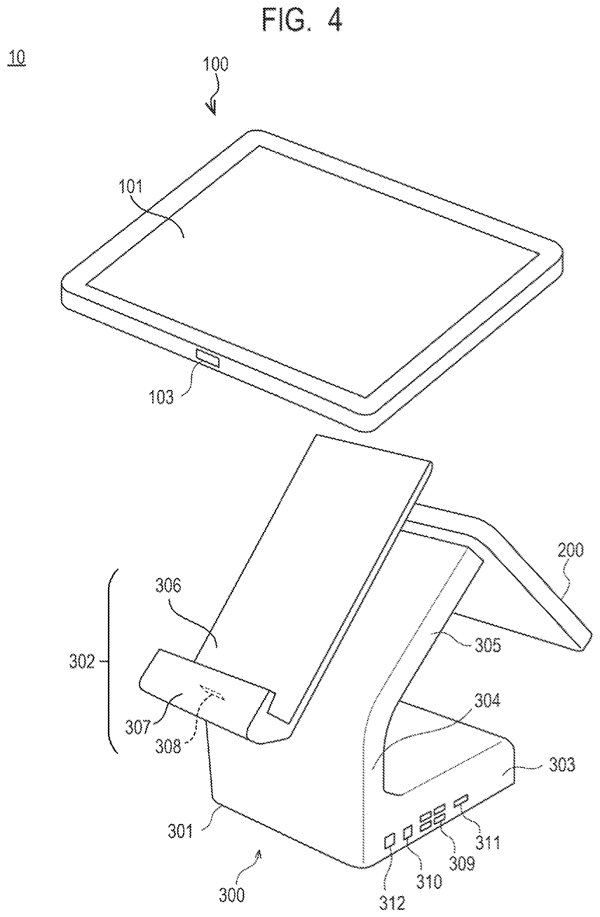

Further, as illustrated in FIG. 2 to FIG. 4, the POS apparatus 10 in the present example embodiment has the salesclerk-side terminal 100, the customer-side terminal 200, and the stand 300 that supports the salesclerk-side terminal 100 in a detachable manner. Herein, FIG. 2 is a perspective view of the POS apparatus 10 when viewed from the front side of the salesclerk-side terminal 100 when the salesclerk-side terminal 100 is in a connected state to the stand 300. FIG. 3 is a perspective view of the POS apparatus 10 illustrated in FIG. 2 when viewed from the front side of the customer-side terminal 200. FIG. 4 is a perspective view of the POS apparatus 10 when viewed from the salesclerk-side terminal 100 when the salesclerk-side terminal 100 is in a state detached from the stand 300.

A POS application program having a product sales proceed registration function, a checkout function, a product information registration function, an inventory management function, or the like is installed in the salesclerk-side terminal 100. Thus, the salesclerk-side terminal 100 functions as a part of the POS apparatus 10.

Further, the salesclerk-side terminal 100 is used for different purposes or the same purpose for the connected state and the detached state. The salesclerk-side terminal 100 switches the function thereof when detached from the stand 300. For example, the salesclerk-side terminal 100 in the detached state functions as a handy terminal that performs an inventory management process. When the salesclerk-side terminal 100 in the detached state is carried away by a salesclerk from the register counter to a place such as a warehouse in the shop, the salesclerk-side terminal 100 performs the inventory management process. The inventory management process includes inspection, registration of a product, stocktaking, ordering, or the like.

The salesclerk-side terminal 100 has substantially a rectangular operator display 101. The operator display 101 has a touch panel 102 (see FIG. 5). Accordingly, the operator display 101 functions as a first display unit and a first input unit. When an application program is started up in the salesclerk-side terminal 100, the operator display 101 displays various information to the salesclerk. Further, the salesclerk can operate the application program by touch input on the operator display 101.

The stand 300 has a base part 301 and a holder part 302 (see FIG. 4). The base part 301 functions as a support member that supports the salesclerk-side terminal 100 and the customer-side terminal 200. Furthermore, the base part 301 functions as a casing that accommodates therein a power supply unit 313, an external interface (I/F) 314, or the like described later.

The base part 301 has a bottom portion 303 placed on an installation place such as the register counter or the like and a plate-like leg portion 304 extending upward from one end of the bottom portion 303. The upper part of the leg portion 304 is a slope portion 305 inclined toward the other end side of the bottom portion 303 with respect to the perpendicular direction.

The customer-side terminal 200 has substantially a rectangular customer display 201. In examples of FIG. 2 to FIG. 4, the customer-side terminal 200 is attached to the upper end of the slope portion 305 of the stand 300 so that the customer display 201 faces diagonally upwards.

The customer display 201 is not particularly limited and may be formed of various displays. For example, the customer display 201 is formed of a liquid crystal display, an organic light emitting diode (OLED) display, a light emitting diode (LED) display, a vacuum fluorescent display (VFD), a fluorescent indicator panel (FIP), or the like. Further, since the customer display 201 of the customer-side terminal 200 is a touch panel type, the customer-side terminal 200 can accept touch input performed on the customer display 201 by the customer.

The customer-side terminal 200 displays a customer window on the customer display 201 in response to the control of the salesclerk-side terminal 100. The customer window is a window used for presenting various information such as checkout information (data for customer) to a customer. The checkout information displayed on the customer window may be, for example, a name of a product processed for payment, a quantity of the product, a selling price, a discount price, a total amount, a tax amount, a receipt amount, a change amount, or the like. Further, the customer-side terminal 200 can display information related to an advertisement, a promotion, an event, or the like on the customer display 201 to a customer in response to the control of the salesclerk-side terminal 100.

Further, the customer display 201 has a touch panel 202 (see FIG. 5). Accordingly, the customer display 201 functions as a second display unit and a second input unit. When an application program is started up in the salesclerk-side terminal 100 or the customer-side terminal 200, the customer display 201 displays various information to a customer. Further, the customer may operate the application program by touch input on the customer display 201.

Further, in the stand 300, the holder part 302 is provided on the upper slope face of the slope portion 305. The holder part 302 of the present example embodiment is located adjacent to the customer display 201 and supports the salesclerk-side terminal 100 in a detachable manner on the back side of the customer display 201.

The holder part 302 has a back-support portion 306 and a hook portion 307 provided to the lower end of the back-support portion 306 and supports the salesclerk-side terminal 100. With the salesclerk-side terminal 100 being supported by the holder part 302, a salesclerk and a customer facing the salesclerk may communicate with each other in a face-to-face manner while viewing the operator display 101 and the customer display 201, respectively. Note that a mechanism by which the holder part 302 holds the salesclerk-side terminal 100 in a detachable manner is not limited to the above mechanism, and various mechanisms may be used.

Moreover, an interconnecting connector 308 is provided to the holder part 302. The interconnecting connector 308 electrically connects the salesclerk-side terminal 100 supported by the holder part 302 to the stand 300. In the example of FIG. 4, the interconnecting connector 308 is provided to the hook portion 307 of the holder part 302. When an interconnecting connector 103 provided to the salesclerk-side terminal 100 is connected to the interconnecting connector 308, the salesclerk-side terminal 100 is electrically connected to the customer-side terminal 200 via the stand 300.

The interconnecting connector 308 electrically connects the salesclerk-side terminal 100 attached in the holder part 302 to the customer display 201. Accordingly, the salesclerk-side terminal 100 can control display of the customer display 201 connected via the interconnecting connectors 103 and 308. Note that the connection form of the interconnecting connectors 103 and 308 is not particularly limited, and various schemes can be employed.

Further, a plurality of Universal Serial Bus (USB) connectors 309, a communication connector 310, a display terminal 311, and a power supply connector 312 used for connecting peripheral devices 400 are provided in the lower side part of the base part 301. Further, the positions of the base part 301 in which respective terminals are provided are not particularly limited.

As the peripheral device 400, for example, the contactless IC reader/writer 401, the printer 402, the cash drawer 403, the code scanner 404, or the like may be connected to the USB connectors 309.

The communication connector 310 is a terminal used for connecting a communication cable such as a LAN cable. The communication connector 310 is a LAN connector such as RJ-45, for example. The stand 300 is connected to the network 13 via a communication cable connected to the communication connector 310.

The display terminal 311 is a terminal used for connecting an external display. The display terminal 311 is, for example, a High-Definition Multimedia Interface (HDMI) (registered trademark) terminal, a Digital Visual Interface (DVI) terminal, a Video Graphics Array (VGA) terminal, or the like.

The power supply connector 312 is a terminal used for supplying power. An alternating current (AC) adapter is connected to the power supply connector 312. The AC adapter converts AC power from commercial power supply into DC power and supplies the DC power to the stand 300.

FIG. 5 illustrates an example of a hardware configuration of the POS apparatus 10. As illustrated in FIG. 5, the salesclerk-side terminal 100 has a central processing unit (CPU) 104, an internal storage 105, and a random access memory (RAM) 106. Further, the salesclerk-side terminal 100 has a wireless communication device 107 and a camera 108. Further, the salesclerk-side terminal 100 has a display controller 109 and the operator display 101. Further, the salesclerk-side terminal 100 has an interconnecting connector 103, an external I/F 110, and a USB connector 112. Furthermore, the salesclerk-side terminal 100 has a power supply unit 113 and a battery 114.

The CPU 104, the internal storage 105, the RAM 106, the wireless communication device 107, the camera 108, the interconnecting connector 103, the display controller 109, and the external I/F 110 are connected to a bus line 111. The USB connector 112 is connected to the external I/F 110. The power supply unit 113 is connected to the interconnecting connector 103. The battery 114 is connected to the power supply unit 113.

The CPU 104 operates by executing a program stored in the internal storage 105 and controls the overall operation of the salesclerk-side terminal 100. That is, the CPU 104 functions as a first control unit. Further, the CPU 104 executes a POS application program stored in the internal storage 105 to perform various processes as the POS apparatus 10. The RAM 106 provides a memory area required for the operation of the CPU 104.

The CPU 104 controls the operation state of the peripheral device 400 such as the contactless IC reader/writer 401, the printer 402, the cash drawer 403, the code scanner 404, or the like. Specifically, the active state is a state where power is supplied to the peripheral device 400 and the peripheral device 400 is able to normally operate. The inactive state includes a state where the peripheral device 400 does not normally operate, such as a powered-off state where no power is supplied to the peripheral device 400 and, in addition, a state where a reset state of the peripheral device 400 is maintained.

The internal storage 105 is formed of a storage medium such as a nonvolatile memory, a hard disk drive, or the like. The internal storage 105 stores a program executed by the CPU 104, data referenced by the CPU 104 in execution of the program, or the like.

The wireless communication device 107 wirelessly communicates with the access point 12 or the like in accordance with the specification of a wireless LAN, for example, under the control of the CPU 104. The specification of a wireless LAN may be Wi-Fi (registered trademark) or the like conforming to IEEE802.11 defined by the Institute of Electrical and Electronics Engineers, Inc. (IEEE).

Further, the wireless communication device 107 wirelessly communicates with the peripheral device 400 having a corresponding wireless communication function in accordance with a Bluetooth (registered trademark) communication scheme, an infrared communication scheme, or the like under the control of the CPU 104. Thereby, the CPU 104 can control the peripheral device 400 via the wireless communication device 107.

The camera 108 captures an image of an object and outputs image data of the object under the control of the CPU 104. For example, the salesclerk-side terminal 100 in the detached state can also function as an image scanner that captures an image of a code symbol provided on a product or the like by the camera 108 and acquires information from the captured image. A code symbol is not particularly limited and may be, for example, a one-dimensional code such as a barcode, a two-dimensional code such as a QR code (registered trademark), or the like.

The display controller 109 controls the display on the operator display 101 and monitors touch input performed on the operator display 101 (touch panel 102) to acquire input data caused by the touch input under the control of the CPU 104.

As described above, the interconnecting connector 103 is connected to the interconnecting connector 308 of the stand 300 when the salesclerk-side terminal 100 is attached to the stand 300. The CPU 104 can control the customer-side terminal 200, the stand 300, and the peripheral device 400 when the interconnecting connector 103 is connected to the interconnecting connector 308.

The external I/F 110 controls transmission and reception of data via the USB connector 112 under the control of the CPU 104. The peripheral device 400 connectable in the USB specification can be connected to the USB connector 112 in a detachable manner if necessary. The CPU 104 can control the peripheral device 400 connected to the USB connector 112.

The power supply unit 113 supplies power supplied from the battery 114 as driving power to each component of the salesclerk-side terminal 100. The salesclerk-side terminal 100 in the detached state can be operated by the driving power from the battery 114.

Further, when the salesclerk-side terminal 100 is in the connected state, charging power and driving power are supplied to the power supply unit 113 from a power supply unit 313 of the stand 300 via the interconnecting connectors 103 and 308. The power supply unit 113 charges the battery 114 with the charging power supplied from the power supply unit 313. Further, the power supply unit 113 supplies the driving power supplied from the power supply unit 313 to each component of the salesclerk-side terminal 100. The salesclerk-side terminal 100 in the connected state is operated by the driving power supplied from the power supply unit 313.

As illustrated in FIG. 5, the customer-side terminal 200 has a CPU 203, an internal storage 204, a RAM 205, a customer display 201, and a display controller 206. Respective devices (203, 204, 205, 201, and 206) have the same functions as the CPU 104, the internal storage 105, the RAM 106, the operator display 101, and the display controller 109 of the salesclerk-side terminal 100, respectively. Note that the operation of the customer-side terminal 200 differs between a state where the salesclerk-side terminal 100 is connected to the stand 300 (connected state) and a state where the salesclerk-side terminal 100 is detached from the stand 300 (detached state).

Specifically, when the salesclerk-side terminal 100 is in a detached state, the CPU 203 operates by executing a program stored in the internal storage 204 and controls the overall operation of the customer-side terminal 200. That is, the CPU 203 functions as a second control unit. Further, the CPU 203 executes a POS application program stored in the internal storage 204 to perform various processes as the POS apparatus 10. The RAM 205 provides a memory area required for the operation of the CPU 203.

In contrast, when the salesclerk-side terminal 100 is in the connected state, the CPU 203 of the customer-side terminal 200 operates in cooperation with the CPU 104 of the salesclerk-side terminal 100. In such a case, the display controller 206 controls the display on the customer display 201 under control of the CPU 104 of the salesclerk-side terminal 100.

Further, as described above, the stand 300 has an interconnecting connector 308, a USB connector 309, a communication connector 310, a display terminal 311, and a power supply connector 312. Further, the stand 300 has a power supply unit 313, an external I/F 314, a wired communication device 315, a wireless communication device 316, and an attachment/detachment sensor 317.

In the present example embodiment, the customer-side terminal 200 and the stand 300 are integrally provided. Thus, the interconnecting connector 308, the external I/F 314, the wired communication device 315, and the wireless communication device 316 are connected to the bus line 207 in the same manner as the CPU 203. The power supply unit 313 is connected to the interconnecting connector 308. The power supply connector 312 is connected to the power supply unit 313. The USB connector 309 is connected to the external I/F 314. The communication connector 310 is connected to the wired communication device 315.

The power supply unit 313 supplies power supplied from the AC adapter connected to the power supply connector 312 as driving power to each component of the stand 300. Further, the power supply unit 313 supplies power supplied from the AC adapter as driving power to the peripheral device 400 that can be operated by bus power connected to the USB connector 309. Further, when the salesclerk-side terminal 100 is in the connected state, the power supply unit 313 supplies charging power and driving power to the power supply unit 113 of the salesclerk-side terminal 100 via the interconnecting connectors 103 and 308.

The external I/F 314 controls transmission and reception of data via the USB connector 309 under the control of the CPU 203. As the peripheral devices 400 connectable in the USB specification, the code scanner 404, the contactless IC reader/writer 401, the printer 402, and the cash drawer 403 are connected to the plurality of USB connectors 309 in a detachable manner. The CPU 203 can control the peripheral devices 400 connected to the USB connectors 309 in the same manner as the CPU 104 of the salesclerk-side terminal 100.

The wired communication device 315 is connected to the network 13 via a communication cable connected to the communication connector 310 and transmits and receives data via the network 13. The CPU 203 can transmit and receive data to and from the shop server 11 or the like on the network 13 via the wired communication device 315 of the stand 300 in the same manner as the CPU 104 of the salesclerk-side terminal 100.

The wireless communication device 316 also wirelessly communicates with a peripheral device 400 having a corresponding wireless communication function in accordance with a Bluetooth (registered trademark) communication scheme, an infrared communication scheme, or the like under the control of the CPU 203.

The attachment/detachment sensor 317 detects an attachment/detachment state of the salesclerk-side terminal 100 and outputs an output signal in accordance with the attachment/detachment state. The attachment/detachment sensor 317 may be to detect attachment/detachment of the salesclerk-side terminal 100 by an optical method, an electrical method, a mechanical method, or other methods. When the salesclerk-side terminal 100 is detached from the stand 300, the cooperation related to the checkout process is canceled between the salesclerk-side terminal 100 and the customer-side terminal 200. Thus, based on the output signal of the attachment/detachment sensor 317, the CPU 203 can determine whether or not the salesclerk-side terminal 100 is in a state ready to perform the checkout process. Note that the method for determining whether or not the salesclerk-side terminal 100 is in a state ready to perform the checkout process is not limited to the method described above. For example, when the salesclerk-side terminal 100 is connected to the customer-side terminal 200 in short-range communication without being routed via the stand 300, it can be determined that the salesclerk-side terminal 100 is in a state unable to perform the checkout process when the communication is disconnected or when the intensity of the communication becomes weaker.

The contactless IC reader/writer 401 operates under the control of the CPU 104 or the CPU 203 and acquires credit card information or electronic money card information for payment from a contactless IC chip of a customer's device such as a smartphone or a customer's medium such as a card.

The printer 402 is operated under the control of the CPU 104 or the CPU 203 and prints and outputs a receipt or the like. The cash drawer 403 is operated under the control of the CPU 104 or the CPU 203 and opens a drawer that stores coins, bills, or the like in transaction of cash for cash payment.

The code scanner 404 is operated under the control of the CPU 104 or the CPU 203 and reads a code symbol provided on a product or the like on which a checkout process is to be performed. The code symbol is not particularly limited and may be, for example, a one-dimensional or two-dimensional code such as a barcode, a QR code (registered trademark), or the like as described above.

The peripheral device 400 other than the code scanner 404 or the like described above can be connected to the stand 300 and operated if necessary. Other peripheral devices 400 may be, for example, a Personal Identification Number (PIN) pad, an automatic change machine, a programmable keyboard, or the like.

Further, the stand 300 may further have a CPU, an internal storage, a RAM, and the like in the same manner as the salesclerk-side terminal 100 or the customer-side terminal 200. In such a case, the stand 300 can function alone as a computer apparatus.

Note that the hardware configuration illustrated in FIG. 5 is an example, and a device other than the above may be added, or some of the devices may not be provided. Further, some of the devices may be replaced with another device having the same function.

Furthermore, a part of the function of the present example embodiment may be provided by another device via the network 13, or the function of the present example embodiment may be implemented by being distributed in a plurality of devices.

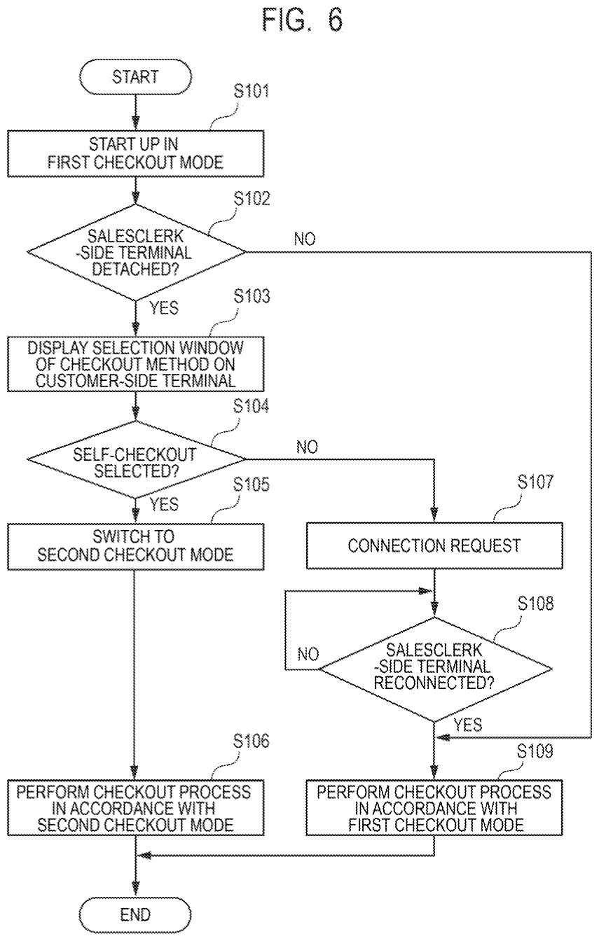

Next, the effect and advantage of the POS system 1 according to the present example embodiment will be described with reference to FIG. 6 to FIG. 10.

FIG. 6 is a flowchart illustrating an example of a switching process of a checkout mode in the POS system 1. The process is started when a power supply switch (not illustrated) of the POS apparatus 10 is pressed, for example. Note that, at the start of the process of FIG. 6, the salesclerk-side terminal 100 has been in a connected state to the stand 300.

In step S101, the CPU 104 of the salesclerk-side terminal 100 is started up in the first checkout mode. At this time, the customer-side terminal 200 is electrically connected to the salesclerk-side terminal 100 via the stand 300 and thus started up at the same time as the salesclerk-side terminal 100. After the startup, the customer window is displayed on the customer display 201 of the customer-side terminal 200.

In step S102, the CPU 203 of the customer-side terminal 200 determines whether or not the salesclerk-side terminal 100 is detached from the stand 300 based on the detection signal from the attachment/detachment sensor 317. Herein, if the CPU 203 of the customer-side terminal 200 determines that the salesclerk-side terminal 100 is detached from the stand 300 (step S102: YES), the process proceeds to step S103. In contrast, if the CPU 203 of the customer-side terminal 200 determines that the salesclerk-side terminal 100 is not detached from the stand 300 (step S102: NO), the process proceeds to step S109.

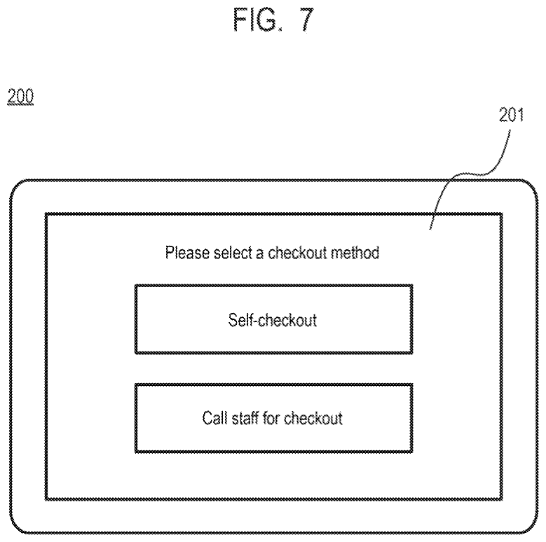

In step S103, the CPU 203 of the customer-side terminal 200 displays a checkout mode selection window on the customer display 201. FIG. 7 is a diagram illustrating an example of a checkout mode selection window displayed on the customer display 201 of the customer-side terminal 200. It is herein illustrated that either “Self-checkout” or “Call staff for checkout” can be selected in the customer window. The “Self-checkout” button corresponds to the “second checkout mode” in which a customer performs the operation from the product registration to payment by himself/herself. In contrast, the “Call staff for checkout” button corresponds to the “first checkout mode” in which a salesclerk performs the operation from the product registration to payment.

In step S104, the CPU 203 of the customer-side terminal 200 determines whether or not “Self-checkout” is selected as a checkout method in the customer window. Herein, if the CPU 203 of the customer-side terminal 200 determines that the “Self-checkout” is selected as a checkout method (step S104: YES), the process proceeds to step S105. In contrast, if the CPU 203 of the customer-side terminal 200 determines that the “Call staff for checkout” is selected as a checkout method (step S104: NO), the process proceeds to step S107.

In step S105, the CPU 203 of the customer-side terminal 200 switches the checkout mode in the POS apparatus 10 to the second checkout mode. Specifically, when the CPU 203 starts up an application program for a checkout process stored in the internal storage 204, this enables the checkout process at the customer-side terminal 200 to be performed.

In step S106, the CPU 203 of the customer-side terminal 200 performs the checkout process in accordance with the second checkout mode. The details of the process will be described later.

In step S107, the CPU 203 of the customer-side terminal 200 issues a connection request to the salesclerk-side terminal 100 detached from the stand 300.

In step S108, the CPU 203 of the customer-side terminal 200 determines whether or not the salesclerk-side terminal 100 is reconnected to the stand 300. Herein, if the CPU 203 of the customer-side terminal 200 determines that the salesclerk-side terminal 100 is reconnected to the stand 300 (step S108: YES), the process proceeds to step S109. In contrast, if the CPU 203 of the customer-side terminal 200 determines that the salesclerk-side terminal 100 is not reconnected to the stand 300 (step S108: NO), the process of step S108 is repeated until the salesclerk-side terminal 100 is connected to the stand 300.

In step S109, the CPU 104 of the salesclerk-side terminal 100 performs the checkout process in accordance with the first checkout mode.

As described above, since the salesclerk-side terminal 100 is in a state unable to perform the checkout process when the salesclerk-side terminal 100 is detached from the stand 300, the customer-side terminal 200 is controlled to be able to perform the checkout process instead of the salesclerk-side terminal 100.

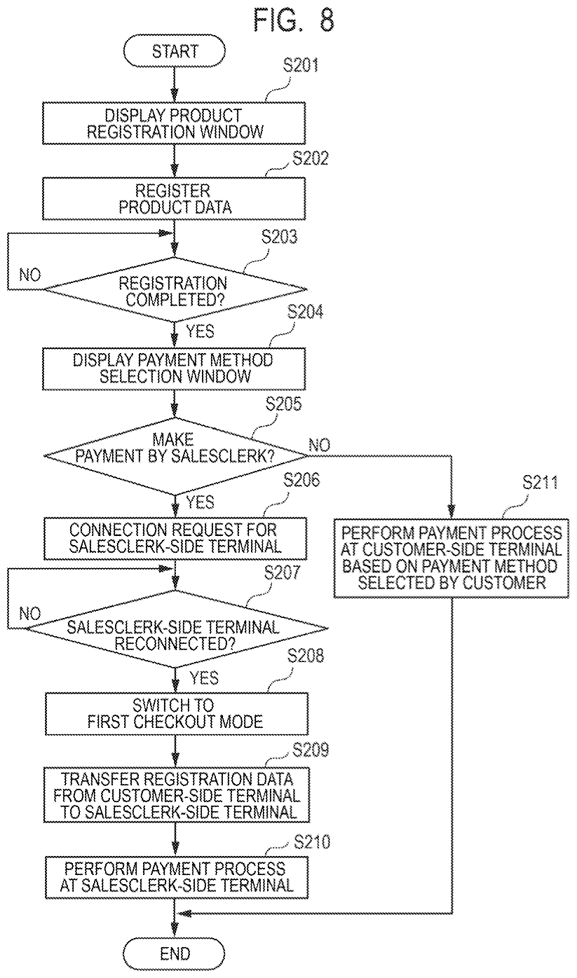

FIG. 8 is a flowchart illustrating an example of a checkout process in the POS system 1. This process is to indicate an example of the process of step S106 of FIG. 6 and is performed when the salesclerk-side terminal 100 is in a detached state from the stand 300, that is, in a state unable to perform the checkout process.

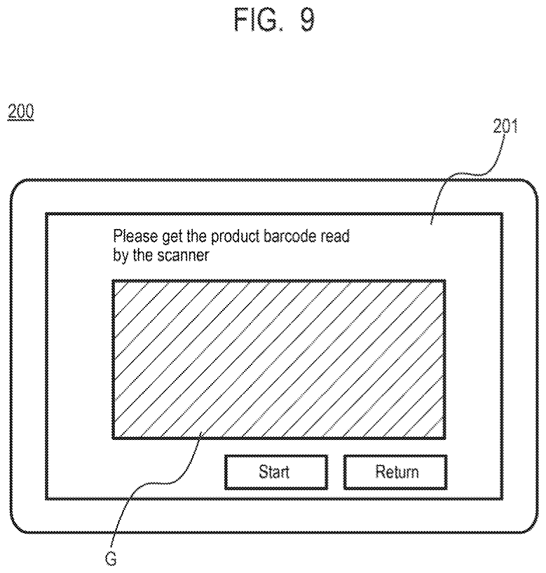

In step S201, the CPU 203 of the customer-side terminal 200 displays a product registration window on the customer display 201. FIG. 9 is a diagram illustrating an example of the product registration window displayed on the customer-side terminal 200. This example illustrates a case where a message to instruct the customer to perform data registration of a purchased product on the customer display 201 (“Please get the product barcode read by the scanner”) and an image G describing how to operate it are displayed.

In step S202, in response to the customer operating the code scanner 404 to get the product barcode read, the CPU 203 of the customer-side terminal 200 registers the product data acquired by the barcode in a storage region such as the internal storage 204.

In step S203, the CPU 203 of the customer-side terminal 200 determines whether or not registration of all the products is completed. Specifically, it is determined whether or not information indicating the end of product registration was input from the customer in the customer display 201. Herein, if the CPU 203 of the customer-side terminal 200 determines that the registration of all the products is completed (step S203: YES), the process proceeds to step S204. In contrast, if the CPU 203 of the customer-side terminal 200 determines that the registration of all the products is not completed (step S203: NO), the process of step S203 is repeated.

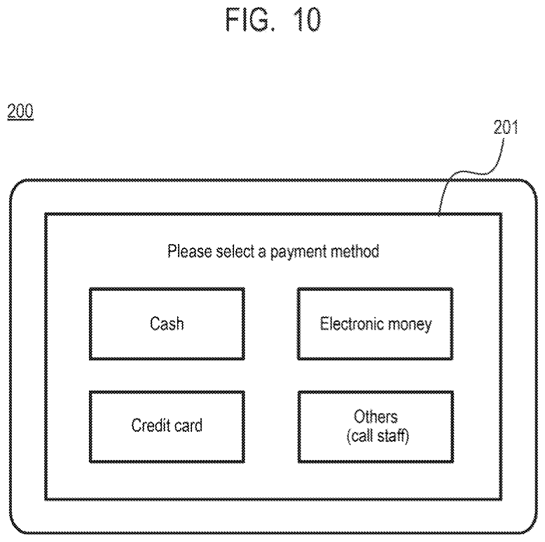

In step S204, the CPU 203 of the customer-side terminal 200 displays a payment method selection window on the customer display 201. FIG. 10 is a diagram illustrating an example of a payment method selection window displayed on the customer-side terminal 200. This example illustrates a case where a message to urge the customer to select a payment method on the customer display 201 (“Please select a payment method”) and buttons corresponding to a plurality of payment methods (Cash/Credit card/Electronic money/Others (call staff)) are displayed. Note that the type of payment methods is not limited to the example of FIG. 10.

In step S205, the CPU 203 of the customer-side terminal 200 determines whether or not “payment by salesclerk” is selected on the customer display 201 as a payment method. In the example of FIG. 10, it is determined whether or not “Others (call staff)” is selected by the customer as a payment method. Herein, if the CPU 203 of the customer-side terminal 200 determines that “payment by salesclerk” is selected as a payment method (step S205: YES), the process proceeds to step S206. In contrast, if the CPU 203 of the customer-side terminal 200 determines that “payment by salesclerk” is not selected as a payment method (step S205: NO), the process proceeds to step S211.

In step S206, the CPU 203 of the customer-side terminal 200 issues a connection request to the salesclerk-side terminal 100 detached from the stand 300. Note that, when a plurality of POS apparatuses 10 are provided in a shop and a combination of the stand 300 and the salesclerk-side terminal 100 can be freely changed, it is preferable to be able to issue a connection request to the salesclerk-side terminal 100 detached from another stand 300.

In step S207, the CPU 203 of the customer-side terminal 200 determines whether or not the salesclerk-side terminal 100 is reconnected to the stand 300. Herein, if the CPU 203 of the customer-side terminal 200 determines that the salesclerk-side terminal 100 is reconnected to the stand 300 (step S207: YES), the process proceeds to step S208. In contrast, if the CPU 203 of the customer-side terminal 200 determines that the salesclerk-side terminal 100 is not reconnected to the stand 300 (step S207: NO), the process of step S207 is repeated.

In step S208, when the CPU 203 of the customer-side terminal 200 completes the second checkout mode, the CPU 104 of the salesclerk-side terminal 100 switches the checkout mode to the first checkout mode.

In step S209, the CPU 203 of the customer-side terminal 200 transfers the product data (payment data) registered at the customer-side terminal 200 to the salesclerk-side terminal 100.

In step S210, the CPU 104 of the salesclerk-side terminal 100 performs a payment process at the salesclerk-side terminal 100. Thereby, the checkout process in accordance with the first checkout mode is completed.

In step S211, the CPU 203 of the customer-side terminal 200 performs a payment process at the customer-side terminal 200 based on the payment method selected by the customer. Thereby, the checkout process in accordance with the second checkout mode is completed.

The POS system 1 according to the present example embodiment can determine whether or not the salesclerk-side terminal 100 is in a state ready to perform a checkout process based on attachment/detachment state between the salesclerk-side terminal 100 and the stand 300 and switch a face-to-face type POS and a self-service type POS at a suitable timing based on the determination result.

As described above, when the salesclerk-side terminal 100 is detached from the stand 300, the POS apparatus 10 is no longer able to perform a checkout process as a face-to-face type POS. However, since the terminal that performs the checkout process is switched from the salesclerk-side terminal 100 to the customer-side terminal 200, this enables the POS apparatus 10 to perform the checkout process as a self-service type POS.

Moreover, when the salesclerk-side terminal 100 that has been detached from the stand 300 is reconnected to the stand 300, that is, when the salesclerk-side terminal 100 returns to be the state ready to perform the checkout process, the salesclerk-side terminal 100 is re-switched from the self-service type POS to the face-to-face type POS.

Note that, when the salesclerk-side terminal 100 is in a detached state and when product data has been registered on the customer-side terminal 200 side, the salesclerk-side terminal 100 may receive the registered data (payment data) when reconnected to the stand 300 and perform a checkout process in cooperation with the customer-side terminal 200.

### Second Example Embodiment

The POS system 1 according to a second example embodiment will be described below. Note that references common to the references provided in the drawings of the first example embodiment refer to the same objects. Thus, the description of features common to the first example embodiment will be omitted, and different features will be described in detail.

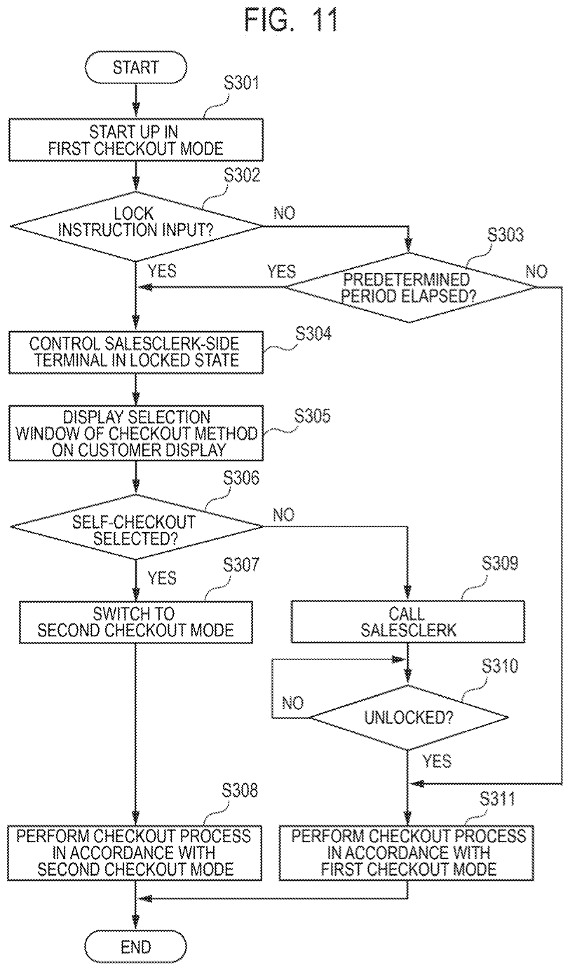

The present example embodiment is different from the first example embodiment only in the method for determining whether or not the salesclerk-side terminal 100 is in a state ready to perform a checkout process. FIG. 11 is a flowchart illustrating an example of a process of switching the checkout mode in the POS system 1 according to the present example embodiment.

In step S301, the CPU 104 of the salesclerk-side terminal 100 is started up in the first checkout mode. At this time, the customer-side terminal 200 is electrically connected to the salesclerk-side terminal 100 via the stand 300 and thus started up at the same time as the salesclerk-side terminal 100. After the startup, a customer window is displayed on the customer display 201 of the customer-side terminal 200.

In step S302, the CPU 104 of the salesclerk-side terminal 100 determines whether or not a lock instruction is input on the operator display 101. Herein, if the CPU 104 of the salesclerk-side terminal 100 determines that the lock instruction is input (step S302: YES), the process proceeds to step S304. In contrast, the CPU 104 of the salesclerk-side terminal 100 determines that the lock instruction is not input (step S302: NO), the process proceeds to step S303.

In step S303, the CPU 104 of the salesclerk-side terminal 100 determines whether or not a period having no input of the authentication information on the salesclerk exceeds a predetermined period. Herein, if the CPU 104 of the salesclerk-side terminal 100 determines that the period having no input of the authentication information on the salesclerk exceeds the predetermined period (step S303: YES), the process proceeds to step S304. In contrast, if the CPU 104 of the salesclerk-side terminal 100 determines that the period having no input of the authentication information on the salesclerk does not exceed the predetermined period (step S303: NO), the process proceeds to step S311.

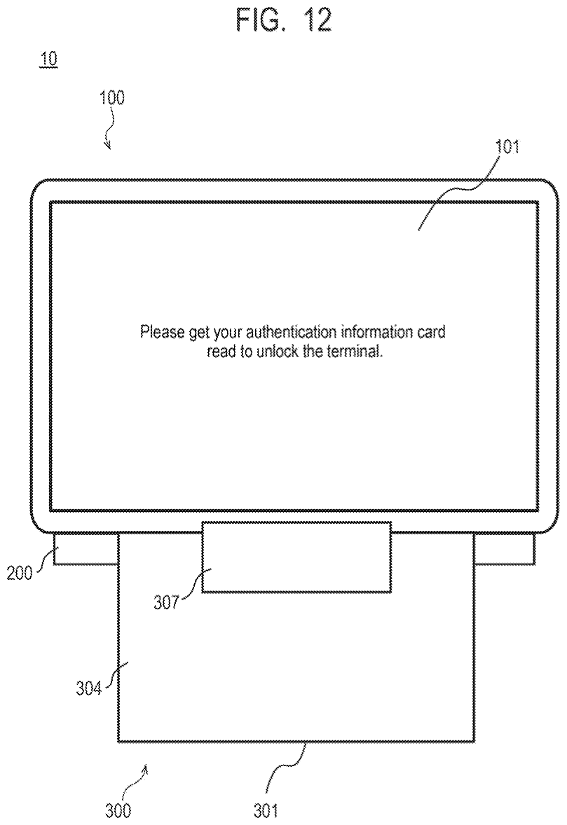

In step S304, the CPU 104 of the salesclerk-side terminal 100 controls the salesclerk-side terminal 100 into a locked state. FIG. 12 is a diagram illustrating an example of a lock window displayed on the operator display 101 of the salesclerk-side terminal 100. This example illustrates that a message to urge the viewer to input authentication information used for unlocking (“Please get your authentication information card read to unlock the terminal”) is displayed on the operator display 101. Note that, in the same manner as the case where the salesclerk-side terminal 100 is detached from the stand 300, a case where the salesclerk-side terminal 100 is in locked state also corresponds to the case where cooperation for a checkout process is cancelled between the salesclerk-side terminal 100 and the customer-side terminal 200.

In step S305, the CPU 203 of the customer-side terminal 200 displays a checkout mode selection window on the customer display 201 in response to the salesclerk-side terminal 100 being controlled to the locked state (see FIG. 7). That is, since the salesclerk-side terminal 100 is connected to the stand 300 but is locked, this corresponds to a state unable to perform a checkout process. In such a case, in the present example embodiment, in the same manner as the case where the salesclerk-side terminal 100 is detached from the stand 300 (the first example embodiment), the CPU 203 of the customer-side terminal 200 urges the customer to select a checkout mode on the customer display 201.

In step S306, the CPU 203 of the customer-side terminal 200 determines whether or not “Self-checkout” is selected as a checkout method in the customer window. Herein, if the CPU 203 of the customer-side terminal 200 determines that “Self-checkout” is selected as a checkout method (step S306: YES), the process proceeds to step S307. In contrast, if it is determined that “Call staff for checkout” is selected as a checkout method (step S306: NO), the process proceeds to step S309.

In step S307, the CPU 203 of the customer-side terminal 200 switches the checkout mode in the POS apparatus 10 to the second checkout mode. Specifically, the CPU 203 starts up an application program used for a checkout process stored in the internal storage 204 and thereby enables the checkout process at the customer-side terminal 200 to be performed.

In step S308, the CPU 203 of the customer-side terminal 200 performs the checkout process in accordance with the second checkout mode (see FIG. 8).

In step S309, the CPU 203 of the customer-side terminal 200 calls a salesclerk via the wired communication device 315 or the wireless communication device 316. A conceivable method of calling a salesclerk may be, for example, a method of identifying and calling a salesclerk such as a method of notifying, of a message, a terminal such as a smartphone possessed by a salesclerk who last used the salesclerk-side terminal 100, a method of notifying, of a message, and calling all the salesclerks except a salesclerk who is serving a customer, or the like.

In step S310, the CPU 203 of the customer-side terminal 200 determines whether or not the salesclerk-side terminal 100 is unlocked. For example, it is determined whether or not a salesclerk who returned to a register counter inputs authentication information. Herein, if the CPU 203 of the customer-side terminal 200 determines that the salesclerk-side terminal 100 is unlocked (step S310: YES), the process proceeds to step S311. In contrast, if the CPU 203 of the customer-side terminal 200 determines that the salesclerk-side terminal 100 is not unlocked (step S310: NO), the process of step S310 is repeated until the salesclerk-side terminal 100 is unlocked.

In step S311, the CPU 104 of the salesclerk-side terminal 100 performs the checkout process in accordance with the first checkout mode.

The POS system 1 according to the present example embodiment can determine whether or not the salesclerk-side terminal 100 is in a state ready to perform a checkout process based on whether or not there is lock control in the salesclerk-side terminal 100 and perform switching between a face-to-face type POS and a self-service type POS at a suitable timing based on the determination result.

Even though the salesclerk-side terminal 100 has been connected to the stand 300, the POS apparatus 10 is unable to perform a checkout process as a face-to-face type POS when the salesclerk-side terminal 100 is controlled in a locked state. However, the terminal that performs the checkout process is switched from the salesclerk-side terminal 100 to the customer-side terminal 200. The POS apparatus 10 is then ready to perform a checkout process as a self-service type POS.

Note that, when the salesclerk-side terminal 100 is in a locked state and when product data has been registered on the customer-side terminal 200 side, the salesclerk-side terminal 100, when unlocked, may receive the registered data (payment data) and perform a checkout process in cooperation with the customer-side terminal 200.

### Third Example Embodiment

The POS system 1 according to a third example embodiment will be described below. Note that references common to the references provided in the drawings of the first example embodiment refer to the same objects. Thus, the description of features common to the first example embodiment will be omitted, and different features will be described in detail.

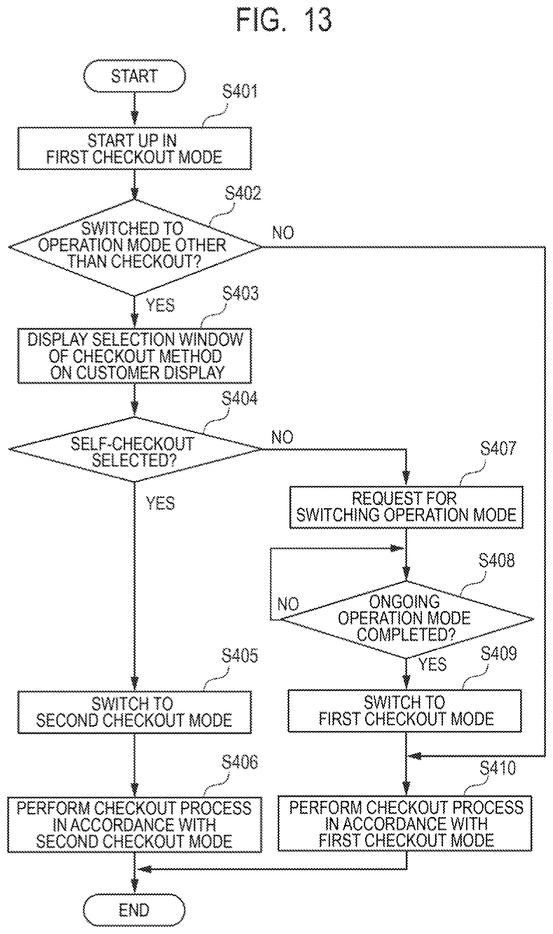

The present example embodiment is different from the first example embodiment only in the method for determining whether or not the salesclerk-side terminal 100 is in a state ready to perform a checkout process. FIG. 13 is a flowchart illustrating an example of a process of switching the checkout mode in the POS system 1 according to the present example embodiment.

In step S401, the CPU 104 of the salesclerk-side terminal 100 is started up in the first checkout mode. At this time, the customer-side terminal 200 is electrically connected to the salesclerk-side terminal 100 via the stand 300 and thus started up at the same time as the salesclerk-side terminal 100. After the startup, a customer window is displayed on the customer display 201 of the customer-side terminal 200.

In step S402, the CPU 203 of the customer-side terminal 200 determines whether or not the execution mode in the salesclerk-side terminal 100 is switched to an operation mode other than the checkout mode. In the same manner as the case where the salesclerk-side terminal 100 is detached from the stand 300, a case where the salesclerk-side terminal 100 is performing an operation mode other than the checkout mode also corresponds to the case where cooperation for a checkout process is cancelled between the salesclerk-side terminal 100 and the customer-side terminal 200. Herein, if the CPU 203 of the customer-side terminal 200 determines that the operation mode in the salesclerk-side terminal 100 is switched to an operation mode other than the checkout mode (step S402: YES), the process proceeds to step S403. In contrast, if the CPU 203 of the customer-side terminal 200 determines that the operation mode in the salesclerk-side terminal 100 is the checkout mode (first checkout mode) (step S402: NO), the process proceeds to step S410.

In step S403, the CPU 203 of the customer-side terminal 200 displays the checkout mode selection window on the customer display 201 in response to the operation mode of the salesclerk-side terminal 100 being a mode other than the checkout process (see FIG. 7). That is, when the salesclerk-side terminal 100 is operating in an operation mode other than the checkout mode even when connected to the stand 300, this corresponds to a state unable to perform a checkout process. In such a case, in the present example embodiment, in the same manner as the case where the salesclerk-side terminal 100 is detached from the stand 300 (first example embodiment), the CPU 203 of the customer-side terminal 200 urges the customer to select a checkout mode on the customer display 201.

In step S404, the CPU 203 of the customer-side terminal 200 determines whether or not “Self-checkout” is selected as a checkout method in the customer window. Herein, if the CPU 203 of the customer-side terminal 200 determines that “Self-checkout” is selected as a checkout method (step S404: YES), the process proceeds to step S405. In contrast, if it is determined that “Call staff for checkout” is selected as a checkout method (step S404: NO), the process proceeds to step S407.

In step S405, the CPU 203 of the customer-side terminal 200 switches the checkout mode in the POS apparatus 10 to the second checkout mode. Specifically, the CPU 203 starts up an application program used for a checkout process stored in the internal storage 204 and thereby causes the checkout process at the customer-side terminal 200 to be ready.

In step S406, the CPU 203 of the customer-side terminal 200 performs the checkout process in accordance with the second checkout mode (see FIG. 8).

In step S407, the CPU 203 of the customer-side terminal 200 issues a request for switching the operation mode to the salesclerk-side terminal 100.

In step S408, the CPU 203 of the customer-side terminal 200 determines whether or not the ongoing operation mode at the salesclerk-side terminal 100 is completed. Herein, if the CPU 203 of the customer-side terminal 200 determines that the ongoing operation mode at the salesclerk-side terminal 100 is completed (step S408: YES), the process proceeds to step S409. In contrast, if it is determined that the ongoing operation mode at the salesclerk-side terminal 100 is not completed (step S408: NO), the process of step S408 is repeated until the ongoing operation mode is completed.

In step S409, the CPU 104 of the salesclerk-side terminal 100 switches the checkout mode (operation mode) to the first checkout mode.

In step S410, the CPU 104 of the salesclerk-side terminal 100 performs the checkout process in accordance with the first checkout mode.

The POS system 1 according to the present example embodiment can determine whether or not the salesclerk-side terminal 100 is in a state ready to perform a checkout process based on an ongoing operation mode at the salesclerk-side terminal 100 and perform switching between a face-to-face type POS and a self-service type POS at a suitable timing based on the determination result.

Even though the salesclerk-side terminal 100 has been connected to the stand 300, the POS apparatus 10 is unable to perform a checkout process as a face-to-face type POS when the salesclerk-side terminal 100 is operating in an operation mode other than the checkout mode. However, the terminal that performs the checkout process is switched from the salesclerk-side terminal 100 to the customer-side terminal 200 when the operation mode of the salesclerk-side terminal 100 is switched to an operation mode other than the checkout mode (for example, an ordering mode, an inspection mode, or the like). The POS apparatus 10 is then ready to perform a checkout process as a self-service type POS.

### Fourth Example Embodiment

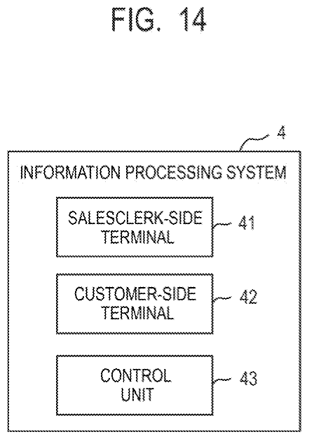

FIG. 14 is a function block diagram of an information processing system 4 according to a fourth example embodiment. As illustrated in FIG. 14, the information processing system 4 has a salesclerk-side terminal 41, a customer-side terminal 42, and a control unit 43. The salesclerk-side terminal 41 is operated by a salesclerk. The customer-side terminal 42 is associated with the salesclerk-side terminal and operated by a customer. Based on a state of the salesclerk-side terminal 41, the control unit 43 performs switching between a first mode in which the salesclerk-side terminal 41 performs a checkout process or the salesclerk-side terminal 41 and the customer-side terminal 42 perform a checkout process in cooperation with each other and a second mode in which the customer-side terminal 42 performs a checkout process.

The information processing system 4 according to the present example embodiment can perform switching between a face-to-face type POS and a self-service type POS at a suitable timing.

### Modified Example Embodiments

The present invention is not limited to the example embodiments described above and can be changed as appropriate within a scope not departing from the spirit of the present invention.

In the above example embodiments, the case where the CPU 203 of the customer-side terminal 200 functions as the control unit to perform switch control of the checkout mode has been described. However, the switch control of the checkout mode may be performed by the CPU 104 of the salesclerk-side terminal 100. Similarly, a control device (CPU) provided in the shop server 11 or the stand 300 may function as the control unit to perform a switch process of the checkout mode in the POS apparatus 10. For example, when a CPU is provided in the stand 300, no CPU may be provided in the salesclerk-side terminal 100 or the customer-side terminal 200. In such a case, the CPU provided in the stand 300 performs the same process by switching display used for a checkout process between the salesclerk-side terminal 100 and the customer-side terminal 200.

The scope of each of the example embodiments also includes a processing method that stores, in a storage medium, a program that causes the configuration of each of the example embodiments to operate so as to implement the function of each of the example embodiments described above, reads the program stored in the storage medium as a code, and executes the program in a computer. That is, the scope of each of the example embodiments also includes a computer readable storage medium. Further, each of the example embodiments includes not only the storage medium in which the program described above is stored but also the program itself. Further, one or two or more components included in the example embodiments described above may be a circuit such as an ASIC, an FPGA, or the like configured to implement the function of each component.

As the storage medium, for example, a floppy (registered trademark) disk, a hard disk, an optical disk, a magneto-optical disk, a compact disk (CD)-ROM, a magnetic tape, a nonvolatile memory card, or a ROM can be used. Further, the scope of each of the example embodiments includes an example that operates on operating system (OS) to perform a process in cooperation with another software or a function of an add-in board without being limited to an example that performs a process by an individual program stored in the storage medium.

Further, a service implemented by the function of each of the example embodiments described above may be provided to a user in a form of Software as a Service (SaaS).

Note that all the example embodiments described above are mere embodied examples in implementing the present invention, and the technical scope of the present invention should not be construed in a limiting sense by these example embodiments. That is, the present invention can be implemented in various forms without departing from the technical concept thereof or the primary feature thereof.

The whole or part of the example embodiments disclosed above can be described as, but not limited to, the following supplementary notes.

### (Supplementary Note 1)

An information processing system comprising:

a salesclerk-side terminal operated by a salesclerk;

a customer-side terminal associated with the salesclerk-side terminal and operated by a customer; and

a control unit that performs switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

### (Supplementary Note 2)

The information processing system according to supplementary note 1, wherein the control unit causes the checkout process to be performed in the second mode when the salesclerk-side terminal is in a state unable to perform the checkout process.

### (Supplementary Note 3)

The information processing system according to supplementary note 2, wherein the control unit determines that the salesclerk-side terminal is unable to perform the checkout process when cooperation between the salesclerk-side terminal and the customer-side terminal is canceled.

### (Supplementary Note 4)

The information processing system according to supplementary note 3 further comprising a stand that is connected to the salesclerk-side terminal and the customer-side terminal and supports the salesclerk-side terminal in a detachable manner,

wherein the control unit causes the checkout process to be performed in the second mode when the control unit detects that the salesclerk-side terminal is detached from the stand.

### (Supplementary Note 5)

The information processing system according to supplementary note 3 or 4, wherein the control unit causes the checkout process to be performed in the second mode when authentication information on the salesclerk has not been input to the salesclerk-side terminal for a predetermined period.

### (Supplementary Note 6)

The information processing system according to any one of supplementary notes 3 to 5, wherein the control unit causes the checkout process to be performed in the second mode when the salesclerk-side terminal performs a process that is different from the checkout process.

### (Supplementary Note 7)

The information processing system according to any one of supplementary notes 3 to 6, wherein the control unit causes the checkout process to be performed in the first mode when the salesclerk-side terminal enters a state ready to perform the checkout process from a state unable to perform the checkout process.

### (Supplementary Note 8]

The information processing system according to supplementary note 7, wherein the salesclerk-side terminal receives payment data related to a product registered by the customer-side terminal and performs the checkout process.

### (Supplementary Note 9)

An information processing method comprising:

operating a salesclerk-side terminal;

operating a customer-side terminal associated with the salesclerk-side terminal; and

performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

### (Supplementary Note 10)

A storage medium storing a program that causes a computer to perform:

operating a salesclerk-side terminal;

operating a customer-side terminal associated with the salesclerk-side terminal; and

performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

This application is based upon and claims the benefit of priority from Japanese Patent Application No. 2018-163017, filed on Aug. 31, 2018, the disclosure of which is incorporated herein in its entirety by reference.

### REFERENCE SIGNS LIST

1 POS system (information processing system)
4 information processing system
10 POS apparatus
11 shop server
12 access point
13 network
100 salesclerk-side terminal
104 CPU (control unit)
200 customer-side terminal
203 CPU (control unit)
300 stand
400 peripheral device

What is claimed is:

1. An information processing system comprising:
a salesclerk-side terminal operated by a salesclerk;
a customer-side terminal associated with the salesclerk-side terminal and operated by a customer; and
a control unit that performs switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

2. The information processing system according to claim 1, wherein the control unit causes the checkout process to be performed in the second mode when the salesclerk-side terminal is in a state unable to perform the checkout process.

3. The information processing system according to claim 2, wherein the control unit determines that the salesclerk-side terminal is unable to perform the checkout process when cooperation between the salesclerk-side terminal and the customer-side terminal is canceled.

4. The information processing system according to claim 3 further comprising a stand that is connected to the salesclerk-side terminal and the customer-side terminal and supports the salesclerk-side terminal in a detachable manner,
wherein the control unit causes the checkout process to be performed in the second mode when the control unit detects that the salesclerk-side terminal is detached from the stand.

5. The information processing system according to claim 3, wherein the control unit causes the checkout process to be performed in the second mode when authentication information on the salesclerk has not been input to the salesclerk-side terminal for a predetermined period.

6. The information processing system according to claim 3, wherein the control unit causes the checkout process to be performed in the second mode when the salesclerk-side terminal performs a process that is different from the checkout process.

7. The information processing system according to claim 3, wherein the control unit causes the checkout process to be performed in the first mode when the salesclerk-side terminal enters a state ready to perform the checkout process from a state unable to perform the checkout process.

8. The information processing system according to claim 7, wherein the salesclerk-side terminal receives payment data related to a product registered by the customer-side terminal and performs the checkout process.

9. An information processing method comprising:
operating a salesclerk-side terminal;
operating a customer-side terminal associated with the salesclerk-side terminal; and
performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.

10. A non-transitory storage medium storing a program that causes a computer to perform:
operating a salesclerk-side terminal;
operating a customer-side terminal associated with the salesclerk-side terminal; and
performing switching between a first mode in which the salesclerk-side terminal performs a checkout process or the salesclerk-side terminal and the customer-side terminal perform the checkout process in cooperation with each other and a second mode in which the customer-side terminal performs the checkout process based on a state of the salesclerk-side terminal.
